(19) United States
(12) Patent Application Publication
(10) Pub. No.: US 2010/0304762 A1
(43) Pub. Date: Dec. 2, 2010

(54) INDOOR TRACKING SYSTEM

(76) Inventor: Bernard Joseph Hall, Elizabeth, NJ (US)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 12/472,718

(22) Filed: May 27, 2009

(51) Int. Cl. H04W 64/00

(52) U.S. Cl. 455/456.5

(57) ABSTRACT

A system and method for indoor tracking that includes a tracking device with a cell modem and a neural network program. The tracking device is placed in known positions within an indoor area to be tracked. The tracking devices requests RF data from reporting cell towers for each known position of the tracking device and feeds the known position data and RF data received from the reporting cell towers to the neural network program, enabling the neural network program to learn a correlation between the known position data and the RF data. The tracking device can then feed RF data from an unknown position to the learned correlation and enable the learned correlation to generate a predicted position of the tracking device.

### FIELD OF THE INVENTION

The present invention is directed generally to tracking systems, more specifically to indoor tracking systems.

### BACKGROUND OF THE INVENTION

GPS tracking has gained immense popularity in recent years, not only for vehicle tracking but also for personnel and package tracking. One of the drawbacks of GPS tracking, however, is its inability to effectively track indoors. Indoor tracking is particularly important for personnel and package tracking.

Tracking devices typically incorporate not only a GPS receive engine, but also a cell modem utilizing mobile phone lines. Popular cell modems are GSM (Global System for Mobile communications) modems and CDMA (Code Division Multiple Access) modems. These cell modems can receive position data and other data from the GPS receive engine and transfer that data to a central server for locating and logging off relevant information. But in the absence of GPS reception, the cell modems cannot provide updated location information until GPS reception is restored.

There have been many other approaches to tracking devices. Some have used cell, TV, or dedicated broadcast towers to locate the position of a receiver unit by means of “triangulation.” The triangulation method relies on accurate measurement of the radial distance or direction of received signals from numerous cell towers. In an indoor setting, however, these signals are easily deflected, thus compromising the accuracy of the location estimation.

U.S. Pat. No. 6,697,630 to Corwith (“Corwith”) discloses an “automatic location identification system” for locating cell telephones dialing 911. The system compares the electronic footprint of a wireless 911 call with field strength data stored from the face of the cell tower in communication with the caller to ascertain the coordinates of a location polygon. But to perform location identification, Corwith must identify a number of cell towers and their location and measure the towers' signal strengths. Thus, similar to triangulation, the system's performance will be compromised in an indoor setting.

By contrast, U.S. Pat. No. 7,411,549 to Krumm (“Krumm”) discloses a location measurement system designed to work indoors. Specifically, the patent discloses an architecture for minimizing calibration effort in an IEEE 802.11 (Wi-Fi or WLAN) device location measurement system that uses a regression component to generate a regression function. Krumm, however, is an internal system. It cannot utilize the hardware and data typically available on current tracking devices, such as cell modems, but requires the use of new transmitters with new modems.

Similarly, U.S. Pat. No. 6,140,964 to Sugiura (“Sugiura”) discloses a method of detecting a position of a radio mobile station in radiocommunications that utilizes a neural network. But similar to Krumm, Sugiura is an internal system that cannot utilize the hardware and data typically available on current tracking devices.

Further, U.S. Pat. No. 6,393,294 to Perez-Breva (“Perez-Breva”) discloses a method for determining the location of a mobile unit and presenting it to a remote party. But similar to Krumm and Sugiura, Perez-Breva cannot utilize the hardware and data typically available on current tracking devices. Perez-Breva requires its mobile units to have appropriate additional circuitry to capture required signals and determine their strength and other parameters. The mobile units or an “Other Party” must also determine which portions of the spectrum to scan.

Others have performed indoor tracking by the placement of bar code strips that are manually read by a bar code reader, or by the placement of a wireless transmitter within a building and the use of carried readers. But like many of the approaches discussed above, these approaches require additional hardware and have limited functionality.

For these reasons, there exists a need for a tracking device that can accurately track indoors while utilizing the hardware and data typically available on current tracking devices.

### SUMMARY OF THE INVENTION

This application discloses a system and method for indoor tracking. A tracking device with a cell modem can feed a neural network data regarding numerous positions of the tracking device and the RF data corresponding with those positions. The neural network can learn a correlation between the known positions and the RF data such that system can subsequently predict the position of the tracking device.

### BRIEF DESCRIPTION OF THE DRAWINGS

FIG. 1 is a block diagram describing the initial setup and position prediction functions of the invention.

FIG. 2 illustrates a floor plan for mapping an indoor area to be tracked.

FIG. 3 illustrates the method by which the invention obtains the RF data for a known position.

### DETAILED DESCRIPTION OF THE INVENTION

The present invention relates to a method for performing reliable indoor tracking. The method utilizes data from cell tower signals, hardware typically available on current tracking devices, and a neural network program.

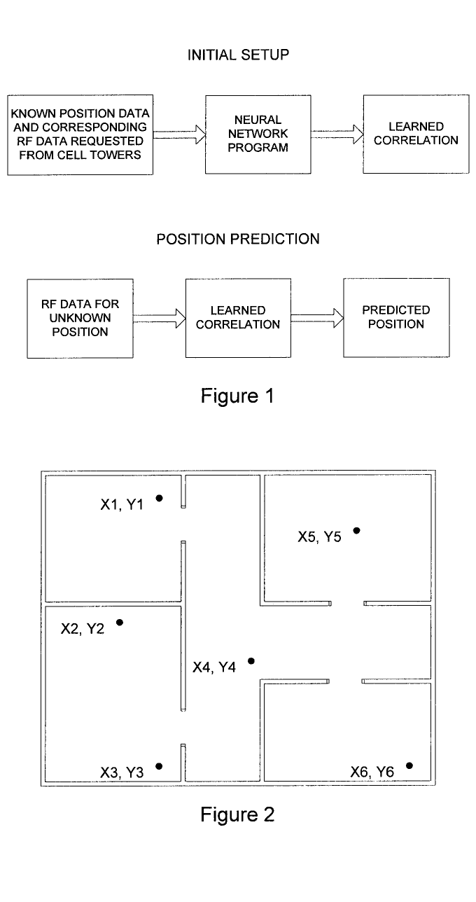

FIG. 1 illustrates the two major phases of the invention. To perform the initial setup, a tracking device is placed in known positions within the indoor area to be tracked. Each known position has known position data, which represent the location for each known position. The known position data can include two-dimensional or three-dimensional coordinates. This initial mapping is described in greater detail below with regard to FIG. 2.

A tracking device can be any device that includes a cell modem for requesting radio frequency (“RF”) data. A cell modem is understood as a modem utilizing mobile phone lines. The cell modem can be a GSM cell modem, or a cell modem incorporating another standard for mobile telephone communications, such as CDMA.

At each known position, the tracking device can request RF data for all the reporting cell towers at that position. The RF data comprises any observable spectral parameters, such as the signal strength for a reporting tower and the timing of a signal from a reporting tower. The RF data need not include the physical location of the transmitting towers. The RF data will be dependent upon many factors, including the distance from the cell tower and any obstructions between the tower and the tracking device. Each known position will have unique RF data.

The invention can then normalize the known position data and the RF data received from the reporting cell towers and feed that data to an artificial neural network program, which can be located at a server. The neural network program can then learn a correlation between the known position data and the RF data.

A neural network program can be understood as any mathematical or computational model based on biological neural networks. Such a neural network program can, for example, learn the correlation between the known position data and the RF data by creating a transfer matrix between the known position data and the RF data. The program can have input nodes and output nodes. The RF data can form the input nodes. For example, the signal strength of the RF data can form seven input nodes, and the timing of the signal can form seven additional input nodes. Further, the location information can be three coordinates forming the three output nodes of the neural network.

For example, the invention can utilize a type of feedforward neural network, such as a backpropagation neural network. In a backpropagation neural network, the known position data (output nodes) and the corresponding RF data (input nodes) can be received. The network can then generate a predicted location output for each location's RF data, and the predicted location outputs can be compared to the desired location outputs (known locations). The network can then calculate the error in each output neuron. For each neuron, the network can then calculate a scaling factor to adjust the predicted location outputs to match the desired location outputs. This is the local error. The network can then adjust the weights of each neuron to lower these local errors and give greater responsibility to those neurons connected by stronger weights.

Neural networks are advantageous in such an application because they are designed to handle data collected within a framework, but not necessarily at previously measured points. Once a small number of points are collected, all other points can provide reasonably accurate data. Further, neural networks are capable of learning from new data. Thus, as additional known location and RF data is collected, the additional data enhances the location ability of the entire range of possible points within the structure.

To perform the position prediction, the tracking device can be placed in an unknown position. The tracking device can then receive RF data from all reporting cell towers, and feed this RF data to the learned correlation. By applying the received RF data to the learned correlation, the learned correlation can generate a predicted position of the tracking device. Further, as indicated above, the invention can subsequently receive additional position data and RF data to enhance the learned correlation between the known position data and the RF data, and thereby improve the accuracy of the predicted positions.

Once the neural network program learns the correlation, the invention can be used to monitor the movement of a person. For example, if a company wanted to monitor the movement of its security guard, the security guard can be given a tracking device to wear. At given times, the tracking device can send RF data to a server, allowing the invention to determine the guard's location at those given times.

The neural network program can also generate a local application that can be transferred to the tracking device for determining the location of the tracking device. By the local application, the tracking device can notify a user when the tracking device is entering a certain area. For example, if a security guard is approaching a dangerous construction zone, his tracking device can determine the location and sound an alarm warning him of the danger.

FIG. 2 illustrates a floor plan for mapping an indoor area to be tracked. In this embodiment, the identified positions are known positions represented by two coordinates: X and Y. The coordinates can represent latitude and longitude. There can also be additional coordinates. For example, the third coordinate can represent the floor at which the tracking device is located. In this embodiment, the tracking device is placed at the six positions and, at each position, RF data is requested from the available cell towers.

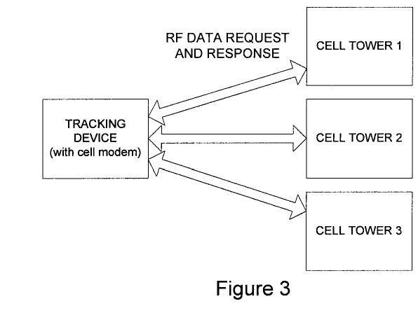

FIG. 3 illustrates the method by which the invention obtains the RF data for a known position. At each known position, the tracking device requests RF data from all reporting cell towers. In FIG. 3, there are three reporting cell towers. Each tower receives a request for RF data, and each responds to the tracking device. For example, the GSM/3GPP standards provide that a phone with a GSM modem can request can request RF data by an SMONC, or similar, command. The AT̂SMONC execute command delivers cell information having 9 values from a maximum of 7 base stations. The response is as follows:
̂SMONC: <MCC>₁, <MNC>₁, <LAC>₁, <cell>₁, <BSIC>₁, <chann>₁, <RSSI>₁, <C1>₁, <C2>₁, <MCC>₂, <MNC>₂, <LAC>₂, <cell>₂, <BSIC>₂, <chann>₂, <RSSI>₂, <C1>₂, <C2>₂, . . .

The responses represent the following parameters:
<MCC>ₙᵤₘ: the mobile country code (3 digits)
<MNC>ₙᵤₘ: the mobile network code (2 or 3 digits)
<LAC>ₙᵤₘ: the location area code (4 hexadecimal digits, e.g., 4EED)
<cell>ₙᵤₘ: the cell identifier (4 hexadecimal digits)
<BSIC>ₙᵤₘ: the base station identity code (2 digits)
<chann>ₙᵤₘ: the Absolute Frequency Channel number
<RSSI>ₙᵤₘ: the received signal level of the BCCH (broadcast control channel) carrier
(0..63). The indicated value is composed of the measured value in dBm plus an offset.
<Cl>ₙᵤₘ: a coefficient for base station reselection.
<C²>ₙᵤₘ: a coefficient for base station reselection.

Thus, the received response can identify, among other things, each available base station and its corresponding received signal level for the BCCH carrier. This RF data, along with the known position data, can be fed to the neural network program for learning a correlation between the known position data and the RF data. Once the correlation is determined, the invention can then receive RF data at other locations, feed this RF data to the learned correlation, and generate a predicted position of the tracking device.

It is to be understood that the descriptions of the present invention have been simplified to illustrate characteristics that are relevant for a clear understanding of the present invention. Those of ordinary skill in the art may recognize that other elements or steps are desirable or required in implementing the present invention. However, because such elements or steps are well known in the art, and because they do not facilitate a better understanding of the present invention, a discussion of such elements or steps is not provided herein. The disclosure herein is directed to all such variations and modifications to such elements and methods known to those skilled in the art.

Those of ordinary skill in the art will recognize that many modifications and variations of the present invention may be implemented. The foregoing description and the following claims are intended to cover all such modifications and variations falling within the scope of the following claims, and the equivalents thereof.

What is claimed is:

1. A method for indoor tracking, comprising:
providing a tracking device comprising a cell modem;
placing the tracking device in known positions within an indoor area to be tracked, and identifying known position data for each known position;
requesting RF data from all reporting cell towers for each known position of the tracking device;
feeding the known position data and the RF data received from the reporting cell towers to a neural network program that learns a correlation between the known position data and the RF data;
placing the tracking device in an unknown position, and receiving RF data for the unknown position from all reporting cell towers; and
applying the received RF data for the unknown position to the learned correlation to generate a predicted position of the tracking device.

2. The method of claim 1, wherein the RF data comprises a signal strength for each reporting tower.

3. The method of claim 1, wherein the RF data comprises a timing of the signals from each reporting tower.

4. The method of claim 1, wherein the neural network program learns the correlation between the known position data and the RF data by creating a transfer matrix between the known position data and the RF data.

5. The method of claim 1, wherein the neural network program is a backpropagation neural network program.

6. The method of claim 1, wherein the RF data forms the input nodes for the neural network program, and the known positions form the output nodes.

7. The method of claim 1, wherein the cell modems are GSM modems, and the cell towers are GSM towers.

8. The method of claim 1, wherein the method further comprises normalizing the known position data and RF data before the known position data and RF data are fed to the neural network program.

9. The method of claim 1, wherein the neural network program can subsequently receive additional position data and RF data.

10. The method of claim 1, wherein the known position data is three-dimensional.

11. The method of claim 1, wherein the known position data and RF data are transmitted to a server.

12. The method of claim 1, wherein the method further comprises (a) generating a local application for determining the location of the tracking device and (b) transferring local application to the tracking device.

13. The method of claim 13, wherein, by the local application, the tracking device can notify a user when the tracking device has entered a certain area.

14. An indoor tracking system, comprising:
a tracking device comprising a cell modem, the tracking device being adapted (a) to be placed in known positions within an indoor area to be tracked, each known indoor position having known position data, and (b) to request RF data from all reporting cell towers for each known position of the tracking device;
a neural network program;
wherein the tracking device is further adapted to feed the known position data and the RF data received from the reporting cell towers to the neural network program, and the neural network program is adapted to learn a correlation between the known position data and the RF data; and
wherein the tracking device is further adapted to request RF data from all reporting cell towers for an unknown position, and the learned correlation is adapted to receive the RF data for the unknown position and generate a predicted position of the tracking device.

15. The system of claim 14, wherein the RF data comprises a timing of the signals from each reporting tower.

16. The system of claim 14, wherein the neural network program learns the correlation between the known position data and the RF data by creating a transfer matrix between the known position data and the RF data.

17. The system of claim 14, wherein the RF data forms the input nodes for the neural network program, and the known positions form the output nodes.

18. The system of claim 14, wherein the neural network program can subsequently receive additional position data and RF data.

19. The system of claim 14, wherein the neural network program is adapted to transfer a local application to the tracking device for determining the location of the tracking device.

20. The system of claim 19, wherein the local application enables the tracking device to notify a user when the tracking device has entered a certain area.
